(19) United States
(12) Patent Application Publication
(10) Pub. No.: US 2016/0032156 A1
(43) Pub. Date: Feb. 4, 2016

(54) PRODUCTS COMPRISING AT LEAST ONE SYNTHETIC-RUBBER PRESSURE-SENSITIVE ADHESIVE COMPRISING BIO-BASED ADHESIVE RESINS AND PRODUCTION PROCESS FOR THESE

(71) Applicant: TESA SE, Hamburg (DE)

(72) Inventors: Thilo DOLLASE, Hamburg (DE); Daniel SCHMITZ-STAPELA, Hamburg (DE); Ernesto BIASOLI, Gavirate (IT)

(73) Assignee: tesa SE, Hamburg (DE)

(21) Appl. No.: 14/772,642

(22) PCT Filed: Mar. 11, 2014
(86) PCT No.: PCT/EP2014/054702

§ 371 Date: Sep. 3, 2015

(30) Foreign Application Priority Data
Mar. 28, 2013 (DE) 10 2013 205 673.7

(51) Int. Cl. C09J 153/00; C09J 7/02

(52) U.S. Cl. CPC C09J 153/00; C09J 7/0221

(57) ABSTRACT

Pressure-sensitive adhesive comprising at least one synthetic rubber based on at least one vinylaromatic (A) and at least one diene (B); the proportion of synthetic rubber being at most 45% by weight; at least one bio-based adhesive resin based to an extent of at least 85% on renewable raw materials and making up a proportion of at least 1% by weight to at most 25% by weight of the entire composition of the pressure-sensitive adhesive.

This is a 371 of PCT/EP2014/054702 filed 11 Mar. 2014, which claims foreign priority benefit under 35 U.S.C. 119 of German Patent Application 102013205673.7 filed Mar. 28, 2013, the entire contents of which are incorporated herein by reference.

The invention relates to a composition of a pressure-sensitive adhesive comprising at least one bio-based adhesive resin and at least one bio-based soft resin, to a laminar pressure-sensitive adhesive medium comprising the pressure-sensitive adhesive, and to processes for the production of the pressure-sensitive adhesive and the laminar pressure-sensitive adhesive media and to the use thereof.

### BACKGROUND OF THE INVENTION

Pressure-sensitive adhesives have been known for a long time. Pressure-sensitive adhesives are adhesives which permit a permanent bond with the substrate with the application of only a relatively low pressure, and they can often be detached from the substrate again after use substantially without leaving a residue. Pressure-sensitive adhesives have a permanent pressure-sensitive adhesive action at room temperature, that is to say they have a sufficiently low viscosity and a high tack, so that they wet the surface of the substrate with the application of only a low pressure. They include in particular compositions which possess pressure-sensitive adhesive properties according to the “Handbook of Pressure Sensitive Adhesive Technology” by Donatas Satas (Satas & Associates, Warwick 1999), in particular those which satisfy the Dahlquist criterion. The adhesiveness of the adhesives and their ability to be detached again are based on their adhesive and cohesive properties. Various compounds are suitable as bases for pressure-sensitive adhesives.

Adhesive tapes that are equipped with pressure-sensitive adhesives, so-called pressure-sensitive adhesive tapes, are nowadays used in many different ways in the industrial and in the private sector. Pressure-sensitive adhesive tapes conventionally consist of a carrier to which the pressure-sensitive adhesive is applied on one side or on both sides. There are also pressure-sensitive adhesive tapes which consist solely of a pressure-sensitive adhesive layer and no carrier, so-called transfer tapes. The composition of the pressure-sensitive adhesive tapes can vary greatly and is governed by the requirements of the various applications. The carriers conventionally consist of plastics films, such as, for example, polypropylene, polyethylene, polyester, or also of paper, woven fabric or nonwoven.

Self-adhesives, or pressure-sensitive adhesives, conventionally consist of acrylate copolymers, silicones, natural rubber or synthetic rubber, such as styrene block copolymers. An important family of pressure-sensitive adhesives, which has found widespread use in various self-adhesive products, are those which are based on synthetic rubber (F. C. Jagisch, J. M. Tancrede in “Handbook of Pressure Sensitive Adhesive Technology”, D. Satas (ed.), 3rd edition, Satas & Associates, Warwick, 1989, p. 346 to 398).

Conventional formulations of pressure-sensitive adhesives based on synthetic rubber comprise at least one thermoplastic elastomer (synthetic rubber, styrene block copolymer), at least one adhesive resin having a softening temperature of greater than or equal to 30° C., and often at least one soft resin having a softening temperature of less than or equal to 30° C. If the pressure-sensitive adhesive is to perform suitably, a suitable balance between adhesion to the target substrate and cohesion of the pressure-sensitive adhesive is always to be established. The thermoplastic elastomer thereby has the function, to a significant degree, of creating sufficient cohesion in the pressure-sensitive adhesive. The adhesive properties are then (finely) adjusted via the adhesive resins, in combination with the thermoplastic elastomer. For high-performance adhesives which have not only good adhesion but also pronounced shear strength, it is difficult to find suitable soft resins. Hydrocarbon-based soft resins or synthetic oils are conventionally used here.

The at least one thermoplastic elastomer generates cohesion by a special physical crosslinking system via the formation of microphases. This results from the combination of the immiscibility of the various types of polymer block contained in the block copolymer, whereby similar regions of different polymer molecules are assigned to one another, so-called microphase separation. By the correct choice of monomers, a glassy nature of a microphase is established at application temperatures below the glass transition temperature of one corresponding polymer block, and the second microphase with an elastomeric nature is established at an application temperature above the glass transition temperature of the second polymer block of corresponding monomers. A thermoreversible crosslinking is thus achieved. The adhesive resins are ideally not compatible with the high-softening-point microphase (“hard phase”) but substantially only with the low-softening-point microphase (“soft phase”). In order to achieve this in adhesives according to the prior art, in particular those which are based on synthetic rubbers such as polystyrene-polybutadiene block copolymers, polystyrene-polyisoprene block copolymers and variants thereof that are hydrogenated and partially hydrogenated in the polydiene block, hydrocarbon resins such as aliphatic, aromatic, alkyl-aromatic resins or terpene resins are typically used. For cost reasons, synthetic resins of raw materials of petrochemistry are in many cases preferred.

Attempts have already been made to use bio-based resins. Bio-based, in particular colophony-based, resins are frequently too unspecific in their compatibility with the various types of polymer block, so that, as well as the desired modification of the soft phase, they also influence the hard phase and thus impair the cohesion in the pressure-sensitive adhesive. The establishment of sufficient cohesion in formulations comprising bio-based resins is a substantial problem, in particular in the case of high-performance adhesives and pressure-sensitive adhesives with high layer thicknesses. The current requirement for the increased use of renewable raw materials also exists for the pressure-sensitive adhesive family of the synthetic rubbers. This is true in particular of products in which pressure-sensitive adhesives are present in high layer thicknesses.

On account of rising raw material prices, ecological points of view, renewability and against the background of ever more scarce crude oil resources, on the one hand, and a worldwide increasing consumption of plastics materials, on the other hand, attempts have been made for some years to produce plastics materials on the basis of renewable raw materials. However, this is a challenge, since the thermoplastic elastomers that are conventionally used are still generated wholly on the basis of raw materials from fossil sources because of today's lack of bio-based alternatives. The aim is, therefore, to reduce the proportion of raw materials from petrochemical sources as far as possible.

The comments made by F. C. Jagisch, J. M. Tancrede in “Handbook of Pressure Sensitive Adhesive Technology” (D. Satas (ed.), 3rd edition, Satas & Associates, Warwick, 1989, p. 346 to 398) teach that, when choosing adhesive resins for synthetic-rubber adhesives, hydrocarbon resins are considered first (Table 16-5, p. 367 and Table 16-7, p. 374). Although the use of polyterpene resins and colophony resins is likewise mentioned qualitatively, they are of lesser importance compared with hydrocarbon resins with regard to a disadvantageous cost-to-performance ratio (p. 372, para. 2). Colophony resins are not recommended in particular for SIS elastomers having a proportion of low styrene (less than 20% by weight) (Table 16-9, p. 376). Far more difficult is the choice of biogenic or bio-based soft resins. Jagisch and Tancrede do not give any recommendations in this regard but restrict themselves to paraffinic and naphthenic oils (Table 16-10, p. 379).

EP 2 371 922 A1 describes hot melt adhesives based on styrene block copolymers. They contain a high proportion of fatty acid esters and additionally adhesive resins (colophony derivatives, polyterpene resins). The adhesives are so adjusted that they have no or only very low tack in the cooled state.

However, no formulations have as yet been found with which, using bio-based raw materials, it has nevertheless been possible to ensure pressure-sensitive adhesives for laminar pressure-sensitive adhesive media in a high layer thickness with good adhesive power on metallic materials such as steel and with good adhesive power on materials having low-energy surfaces, such as polyethylene, with at the same time high shear strength. There continues to be a need to find thermoplastic elastomers which, on account of their synthetic nature, are used in as small a proportion as possible in functional formulations.

Accordingly, it is an object of the present invention to reduce the proportion of petroleum-based components in pressure-sensitive adhesives as far as possible and to find suitable thermoplastic elastomers which, on account of their synthetic nature, are used in as small a proportion as possible in functional formulations or themselves already contain proportions of renewable raw materials. It is a further object of the present invention to provide pressure-sensitive adhesives which have a high adhesive power on metallic materials such as steel but which additionally also exhibit a good adhesive power on materials having low-energy surfaces, such as polyethylene (PE). A further object is to provide a pressure-sensitive adhesive and a laminar pressure-sensitive adhesive medium whose detachment and peeling under conditions according to test A take place without slip-stick (for the slip-stick phenomenon see D. Satas in Handbook of Pressure Sensitive Adhesive Technology, D. Satas (ed.), 3rd edition, Satas & Associates, Warrick, 1999, p. 68f and p. 72). It is a further object of the present invention to create self-adhesive products having pressure-sensitive adhesive layers of high layer thickness, wherein the pressure-sensitive adhesive formulation based on synthetic rubber contains as high a proportion of bio-based components as possible and nevertheless still provides sufficient cohesion. The object is additionally to create pressure-sensitive adhesives with high adhesion and at the same time high cohesion.

The object is achieved by the subject-matter of the independent patent claims and, in addition, is shown in concrete form in the dependent claims as well as in detail in the description.

### SUMMARY OF THE INVENTION

The present invention provides a pressure-sensitive adhesive comprising
(i) at least one synthetic rubber, based on at least one vinyl aromatic compound (A) and at least one diene (B), comprising block copolymers as well as mixtures thereof with the structure A-B-A and/or (A-B)ₙ, (A-B)ₙX or (A-B-A)ₙX, wherein X is the radical of a coupling reagent, and derivatives thereof, wherein n is an integer greater than or equal to 2,
   A is a polymer block (A block polymer) comprising at least one vinyl aromatic compound, and B is a polymer block (B block polymer) comprising at least one diene, in particular the proportion of the at least one diene in the B block polymer is at least 75% by weight,
   and the proportion of the synthetic rubbers in the total composition of the pressure-sensitive adhesive is less than or equal to 45% by weight, preferably less than or equal to 40% by weight, particularly preferably less than or equal to 35% by weight, the synthetic rubber preferably comprises a styrene-isoprene block copolymer (SIS), a styrene-farnesene block copolymer (SFS) or styrene-isoprene-butadiene block copolymers (SIBS),
(ii) at least one bio-based adhesive resin and/or adhesive resin mixture which is based to the extent of greater than or equal to 85% by weight, preferably to the extent of 100% by weight, on renewable raw materials, has a softening point (according to test C) at greater than or equal to 80° C. and less than or equal to 110° C., preferably greater than or equal to 80° C. and less than or equal to 100° C., particularly preferably greater than or equal to 85° C. less than or equal to 100° C., and is present in a proportion of the total composition of the pressure-sensitive adhesive of greater than or equal to 35% by weight, preferably from 35% by weight to less than or equal to 64% by weight, preferably from greater than or equal to 40% by weight to less than or equal to 64% by weight, particularly preferably from greater than or equal to 50% by weight to less than or equal to 64% by weight,
(iii) at least one bio-based soft resin (also called liquid resin) and/or soft resin mixture which is based to the extent of greater than or equal to 85% by weight, preferably to the extent of 100% by weight, on renewable raw materials and is present in a proportion of the total composition of the pressure-sensitive adhesive of greater than or equal to 1% by weight, in particular from greater than or equal to 1% by weight to less than or equal to 25% by weight, preferably from greater than or equal to 2.5% by weight to less than or equal to 22% by weight, particularly preferably from greater than or equal to 5% by weight to less than or equal to 15% by weight,
   in particular, according to an alternative a), from greater than or equal to 10% by weight to less than or equal to 25% by weight, preferably from greater than or equal to 10% by weight to less than or equal to 15% by weight, and in particular, according to an alternative b), the soft resin is advantageously present in an amount of from greater than or equal to 1% by weight to less than or equal to 10% by weight, and
(iv) optionally additives in a proportion of less than or equal to 5% by weight, in particular in each case from less than or equal to 0% by weight to less than or equal to 1% by weight,
   wherein the total pressure-sensitive adhesive without solvent corresponds to 100% by weight (ad 100% by weight), even if a solvent has temporarily been used during processing.

In particular, the diene is selected from at least one isoprene and/or from an isoprene derivative, wherein the diene can be a diene consisting of renewable raw materials.

### BRIEF DESCRIPTION OF THE DRAWING

FIG. 1 illustrates the evaluation of glass transition temperature of polymer blocks.

### DETAILED DESCRIPTION

Within the meaning of the present invention, bio-based/biogenic, or based on renewable raw materials, means that the raw materials used to produce the monomers, polymers, adhesive resins liquid resins and/or soft resins are not based on crude oil and the monomers are also not based on crude oil. Therefore, monomers of cracked crude oil, which are subsequently optionally fermented, are not considered to be bio-based.

According to a preferred embodiment of the invention, the invention consists only of the indicated synthetic rubber(s), of at least one bio-based adhesive resin or adhesive resin mixture, and at least one bio-based soft resin or soft resin mixture (apart from additives in proportions of not more than 5% by weight).

Preference is given to a pressure-sensitive adhesive of the above composition wherein the proportion of all the synthetic rubbers in the total composition of the pressure-sensitive adhesive is less than or equal to 45% by weight, preferably less than or equal to 40% by weight, particularly preferably less than or equal to 35% by weight. The at least one synthetic rubber is a thermoplastic elastomer which can be deformed by the action of heat, the supply of kinetic energy and/or the action of shear force.

The invention further provides a pressure-sensitive adhesive which (i) comprises at least one synthetic rubber wherein (1) the A block accounts for a proportion of from 12% by weight to less than or equal to 30% by weight vinyl aromatic compounds, preferably from greater than or equal to 12% by weight, in particular greater than or equal to 13% by weight, 14% by weight, 15% by weight, 16% by weight, 17% by weight, 18% by weight, 19% by weight, to less than or equal to 20% by weight, from greater than or equal to 15% by weight to less than or equal to 20% by weight, particularly preferably from greater than or equal to 15% by weight to less than or equal to 19% by weight, of the total weight of the at least one synthetic rubber (ad 100%), (2) a triblock copolymer having the structure A-B-A is present in at least one synthetic rubber, and (3) the proportion of triblock copolymers in relation to the synthetic rubber as a whole of 100% by weight is greater than or equal to 50% by weight, preferably from 50% by weight to less than or equal to 100% by weight, preferably from greater than or equal to 60% by weight to less than or equal to 99% by weight, particularly preferably from greater than or equal to 70% by weight to less than or equal to 99% by weight. The remaining non-triblock polymer proportion comprises diblocks of the above-mentioned monomers A and B.

Triblock copolymers within the meaning of the invention having the structure A-B-A include styrene-isoprene-styrene triblock copolymers (SIS), styrene-farnesene-styrene triblock copolymers (SFS) and styrene-isoprene-butadiene triblock copolymers (SIBS), as well as in each case derivatives thereof.

In a preferred embodiment of the invention, the pressure-sensitive adhesive comprises (i) at least one synthetic rubber having a (1) vinyl aromatic compound in the A polymer block selected from the monomers comprising styrene, α-methylstyrene and/or other styrene derivatives, wherein the A blocks independently are homo- or co-polymers, and having (2) at least one diene in the B polymer block according to structure (I) or structure (II)

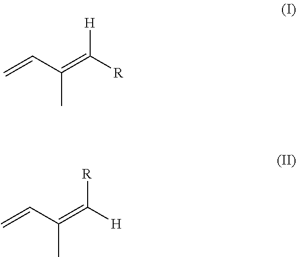

wherein R is a hydrogen or a linear, branched, cyclic or ring-containing and/or unsaturated hydrocarbon radical. R is preferably a hydrogen (isoprene) or C₁₀H₁₇ (a farnesene isomer, preferably from a biogenic source). Styrene-farnesene block copolymers are known, for example, from U.S. Pat. No. 7,655,739 B1.

Within the meaning of the invention, pressure-sensitive adhesives preferably comprise at least one (i) synthetic rubber comprising (1) vinyl aromatic compounds in the A polymer block selected from the monomers comprising styrene, α-methylstyrene and/or other styrene derivatives, wherein the A blocks independently are homo- or co-polymers, and (2) at least one alkene or at least one diene in the B polymer block selected from the monomers comprising ethylene, propylene, 1,3-diene, 1,4-diene. The diene is selected in particular from at least one terpene or terpene derivative according to formula (I) and/or formula (II), preferably sesquiterpene, alpha-/beta-farnesene, isoprene and isoprene derivatives, and the B polymer blocks independently are homo- or co-polymers.

Further comonomers of the B block can be 1,3-dienes, in particular butadiene, wherein the B blocks independently are homo- or co-polymers. Preference is given to B block polymers in which the diene linkage is present to the extent of at least 85% in the form of a 1,4-linkage (measured according to NMR). It is additionally preferred that the ratio of 1,4-cis linkage and 1,4-trans linkage is at least 40:60, preferably at least 50:50 and particularly preferably at least 60:40.

Styrene derivatives within the meaning of the invention can be vinyltoluene as well as vinyl compounds which contain aromatic rings and heterocyclic rings in the alpha-position.

There is present at least one synthetic rubber in which (i) the A blocks each independently have a glass transition temperature Tg (determined by test D) of greater than or equal to 40° C., preferably greater than or equal to 70° C., and (ii) the B blocks each independently have a Tg of less than 0° C., preferably less than −20° C.

It is typical for the pressure-sensitive adhesives according to the invention that the at least one synthetic rubber generates cohesion through a specific physical crosslinking system, resulting from the combination of the immiscibility of the various types of polymer block present in the block copolymer. A microphase separation and establishment of a glass nature of a microphase (at application temperature below its glass transition temperature) is thereby achieved. The second microphase is established with an elastomeric nature (at application temperature above its glass transition temperature). A styene-isoprene-styrene (SIS) triblock copolymer can advantageously be used, as compared with a styrene-butadiene-styrene (SBS) triblock copolymer, because smaller proportions of elastomer can be used and the two-phase morphology is nevertheless still achieved. Furthermore, it is within the meaning of the object of the invention to use as few petrochemical-based raw materials as possible. SBS block copolymers are therefore not preferred. Examples of styrene-isoprene block copolymers which can advantageously be used are compiled in Table 1.

The invention further provides a pressure-sensitive adhesive comprising a bio-based adhesive resin and/or adhesive resin mixture having a proportion of the total composition of the pressure-sensitive adhesive of from greater than or equal to 35% by weight to preferably less than or equal to 64% by weight, preferably from greater than or equal to 40% by weight to less than or equal to 64% by weight, particularly preferably from greater than or equal to 50% by weight to less than or equal to 64% by weight.

At least one bio-based adhesive resin and/or adhesive resin mixture is preferably selected from: (a) non-hydrogenated, partially and/or completely hydrogenated resins based on colophony, (b) non-hydrogenated, partially and/or completely hydrogenated resins based on colophony esters, (c) non-hydrogenated, partially and/or completely hydrogenated resins based on crude tall oil, (d) non-hydrogenated, partially hydrogenated and/or completely hydrogenated resins based on crude tall oil esters, (e) resins based on terpene and/or in each case derivatives thereof.

The main constituent of the above-mentioned colophony resins are resin acids comprising mainly pimaric acid and abietic acid. Further containing and/or synthetically changed resin acids are neoabietic acid, palustric acid, dihydroabietic acid or dehydroabietic acid, iso-pimaric acid, laevopimaric acid and boswellic acid. Tall oil is an oily mixture obtained from solid colophony resin and comprising, in addition to the resin acids already mentioned, fatty acids, in particular unsaturated fatty acids having 18 carbon atoms, and sterols. The resin acids and/or fatty acids can be esterified, in particular by triethylene glycol, glycerol or pentaerythritol, and/or oligomerized and/or unmodified, stabilized, (partially, profoundly or completely) hydrogenated, dehydrogenated or disproportionated. The invention provides an adhesive resin and/or adhesive resin mixture in which at least one resin is in the ester form and preferably has at least one ester bond with a fatty acid, pentaerythritol, glycerol, a resin acid and/or sterane-based compounds, and/or mixtures comprising at least two of the above-mentioned esters and/or resins in the form of mixed esters.

Resins based on terpenes include α-pinene, β-pinene, δ-limonene or dipentene, provided that the raw materials originate to the extent of at least 85% from bio-based sources.

Examples of resins which can be used are:

resins from Eastman, such as DYMEREX colophony, METALYN colophony ester, methyl esters of colophony resin, such as Abalyn™ D-E, Foralyn™ 5020-F, Foralyn™ 5020-F CG, Metalyn™ 200, glycerol esters of colophony resin or of tall-oil-based resins, such as Permalyn™ 2085, Permalyn™ 5095, Permalyn™ 5095-C, hydrogenated or partially hydrogenated colophony resin, such as Foral™ 105-E CG, Foral™ AX-E, Foral™ 85-E, Foral™ 85-E CG, Foral™ 105-E, Dymerex™, Foral™ AX-E, Foralyn™ E, Poly-Pale™′ Staybelite™ Resin-E, pentaerythritol esters of colophony- or tall-oil-based resins, such as Permalyn™ 511-M, Permalyn™ 3100, Permalyn™ 5110, Permalyn™ 5110-C, Permalyn™ 6110, Permalyn™ 6110-M and Permalyn™ 8120;

resins from Pinova, such as Pinvoa™ Ester Gum 8DA, Melhi® NLM, Pexalyn® 9085, Staybelite® Ester 5, Staybelite® Ester 5A, Staybelite® Ester 10, Staybelite® Ester 10A, Foral® 85, Foral® 85LB, Foral® 2085, Pentalyn® A, Pexalyn® 9100, Pexalyn® T100, Pexalyn® 295, Pentalyn® H, Pentalyn® HA, Pentalyn® 830, Pentalyn® FC, Pentalyn® G, Pentalyn® X, Foral® 105, Piccolyte® S85, Piccolyte® C85, Piccolyte® F90, Piccolyte® C105, Piccolyte® F105, Piccolyte® HM106 Ultra;

resins from DRT, such as Granolite SG, Granolite P, Dertoline SG2, Dernatac G95, Dernatac P105, Hydrogral P.

These lists do not claim to be complete but may merely give the person skilled in the art examples of resins which can be used according to the invention.

The composition according to the invention preferably comprises at least one of the above-mentioned resins. The respective esters, if not already obtained commercially as esters, are obtained by reactions with organic compounds selected from the group comprising monovalent and/or polyvalent linear, cyclic, branched, saturated and/or unsaturated hydroxy compounds, such as monool, polyol, hydroabietyl alcohol, fatty acids, resin acids, oleic acids, sugars, and/or linear, cyclic or branched, saturated and/or unsaturated carboxylic acid compounds. The monool is a monohydric alcohol having from 1 to 20 carbon atoms, and polyols such as diols, triols or sugars are hydrocarbon compounds having from 1 to 20 carbon atoms containing from 2 to 10 hydroxy groups, especially from 2 to 8 hydroxy groups, preferably from 3 to 6 hydroxy groups.

The hydrocarbon compound includes hydrocarbon compounds having from 1 to 20 carbon atoms which can be saturated or unsaturated, such as alkanes, cycloalkanes, alkenes, alkynes and homo- and hetero-cyclic aromatic compounds. The alkanes include methyl, ethyl, propyl, butyl, hexyl through decyl to cosyl groups. The hydrocarbon group can be in particular an alkyl, alkylaryl, alkylene or aryl group or a derivative thereof, wherein the hydrocarbon group optionally contains O, N or S atoms.

Monools are selected from alcohols, aminoalcohols, monohydroxy-functional polyethers. A monohydroxy-functional polyether within the meaning of the invention is a polymeric ether having from 1 to 100 carbon atoms, from 3 to 80 carbon atoms, preferably from 5 to 40 carbon atoms, particularly preferably from 5 to 30 carbon atoms, and at least two ether groups comprising at least one hydroxy group. Preferred polyethers are obtained from bio-based compounds such as fats or oils and include polyethylene glycol, polypropylene glycol and polyhydrofuran, without implying any limitation. Examples of aminoalcohols, without implying any limitation, are monoethanolamine, or 2-aminoethanol, 2-(2-am inoethoxy)ethanol, 1-am inopropan-2-ol and 2-amino-2-ethyl-1,3-propanediol. Preference is given to hydroabietyl alcohol and derivatives thereof. Polyols are selected from diols, triols, and polyether polyols having from 1 to 100 carbon atoms. Diols within the meaning of the invention are organic compounds having two alcoholic hydroxy groups and are subdivided into a) polyethylene glycols, including alpha,omega-diols such as diethylene glycol, triethylene glycol and polyethylene glycol, b) endiols, c) aldehyde hydrates such as methanediol derived from formaldehyde, and d) dihydroxy aromatic compounds. The diol is preferably an alpha,omega-diol having from 1 to 100 carbon atoms, dihydroxycyclohexanediol, dihydroxyaryl, particularly preferably a 1,2-diol, 1,3-propanediol and 1,4-butanediol is. Preference is given to diols such as glycol and ethylene glycol and to polyols such as glycerol and pentaerythritol. Diols are particularly preferably obtained from bio-ethanol.

The carboxylic acid compound includes mono-carboxylic acid compounds having from 4 to 30 carbon atoms, from 8 to 24 carbon atoms, preferably from 12 to 18 carbon atoms, which can be optionally substituted. Monocarboxylic acid compounds include fatty acids which are saturated and mono- or poly-unsaturated. Saturated fatty acids are also allocated to the alkanoic acids and have no double bonds between the carbon atoms. Unsaturated fatty acids are alkenoic acids having at least one double bond. Polyunsaturated fatty acids have at least two double bonds.

The adhesive resin according to the invention in the pressure-sensitive adhesive preferably has at least one ester bond with a fatty acid, pentaerythritol, glycerol, a resin acid and/or sterane-based compounds, and/or the adhesive resins according to the invention are present in the form of mixtures comprising at least two of the above-mentioned esters and/or resins as mixed esters. In particular, the compounds contained in the colophony, such as fatty acids, steroids, resin acids and derivatives thereof, can each independently enter into ester bonds with one another.

Preference is given within the meaning of the invention to hydrogenated resins, in particular hydrogenated colophony ester resins (example Pentalyn H, Foral 85). Preferably a substantially completely hydrogenated resin. Particular preference is given to the use of adhesive resins and/or adhesive resin mixtures which have a softening point (ring and ball, test C) of from greater than or equal to 80° C. to less than or equal to 110° C., preferably greater than or equal to 85° C. and less than or equal to 100° C.

The present invention further provides pressure-sensitive adhesives comprising at least one bio-based soft resin and/or soft resin mixture having a melt viscosity at 25° C. and 1 Hz (determined by test E) of at least 25 Pa*s, preferably of at least 50 Pa*s, wherein the proportion thereof in the total composition of the pressure-sensitive adhesive is greater than or equal to 2.5% by weight.

The pressure-sensitive adhesive according to the invention comprises according to an alternative a) at least one soft resin and/or soft resin mixture in a proportion of the total composition of the pressure-sensitive adhesive of from greater than or equal to 2.5% by weight to less than or equal to 22% by weight, preferably from greater than or equal to 10% by weight to less than or equal to 25% by weight, the at least one soft resin preferably has a melt viscosity at 25° C. and 1 Hz of greater than or equal to 25 Pa*s, preferably greater than or equal to 50 Pa*s, or, according to another alternative b), in a proportion of the total composition of the pressure-sensitive adhesive of from greater than or equal to 1% by weight to less than or equal to 10% by weight, in particular according to alternative b) the at least one soft resin has a melt viscosity at 25° C. and 1 Hz of less than or equal to 25 Pa*s.

Likewise preferably, the proportion of the at least one soft resin in the total composition of the pressure-sensitive adhesive can be from greater than or equal to 5% by weight to 15% by weight, the proportion of the at least one soft resin according to an alternative a) is particularly preferably from greater than or equal to 10% by weight to 25% by weight, preferably from 15% by weight to 25% by weight, in particular this soft resin has a melt viscosity at 1 Hz and 25° C. of greater than or equal to 25 Pa*s, preferably greater than or equal to 50 Pa*s. Furthermore, the at least one soft resin has a softening temperature of less than or equal to 30° C., preferably less than or equal to 25° C. Liquid resins, which are included in the soft resins, also count as soft resins.

An advantageous variant is that the at least one soft resin has a melt viscosity at 25° C. and 1 Hz (determined by test E) of at least 25 Pa*s, preferably at least 50 Pa*s. In a further embodiment, where required, at least one soft resin can have a melt viscosity at 25° C. and 1 Hz of at least 25 Pa*s and at least a second can have a melt viscosity at 25° C. and 1 Hz of at least 50 Pa*s, so that mixtures of soft resins of different melt viscosity are obtained. Preference is given according to an alternative a) to a pressure-sensitive adhesive composition comprising a proportion of from greater than or equal to 10% by weight to less than or equal to 25% by weight of at least one soft resin having a melt viscosity at 25° C. and 1 Hz of greater than or equal to 25 Pa*s, preferably of greater than or equal to 50 Pa*s. The proportion for these soft resins can also be less than or equal to 10% by weight.

A further advantageous variant is that the soft resin has a melt viscosity at 1 Hz and 25° C. of less than or equal to 25 Pa*s. The proportion is then greater than or equal to 1% by weight and less than or equal to 10% by weight.

The (iii) at least one bio-based soft resin and/or soft resin mixture thereby preferably comprises at least one polyether, a polyether colophony ester, polyethylene glycol, polyethylene glycol colophony ester, polypropylene glycol, polypropylene glycol colophony ester, polypropylene/polyethylene glycol colophony ester, wherein diethylene glycol, dipropylene glycol is considered to be a polyether, preferably the at least one soft resin comprises a triethylene glycol colophony ester and/or derivatives of triethylene glycol colophony ester, hydrogenated annellated aromatic compounds, hydroabietyl alcohol ([1R-(1α,4aβ,4bα,10aα)]-dodecahydro-7-isopropyl-1,4a-dimethylphenanthrene-1-methanol), dihydroabietyl alcohol, vegetable oil, in particular sunflower oil, terpene-based resins.

Suitable as the soft resin components are monovalent and/or polyvalent linear, cyclic, branched, saturated and/or unsaturated hydroxy compounds, such as monools and polyols, linear, cyclic, branched, saturated and/or unsaturated carboxylic acid compounds and/or alkanes and/or dienes.

The above list of monools and polyols and also of carboxylic acid compounds can likewise be used for the choice of soft resins. There are to be added as preferred compounds in the soft resin and/or soft resin mixture hydroabietyl alcohol, triethylene glycol as polyether and, as preferred fatty acids, sunflower oil, palm oil, soybean oil, corn oil, containing unsaturated fatty acids such as oleic acid, linoleic acid and linolenic acid. Preference is given within the meaning of the invention to di- to poly-unsaturated fatty acids having from 12 to 18 carbon atoms, preferably having 18 carbon atoms.

Alkanes and/or dienes include terpene-based resins and contain dienes such as substituted and unsubstituted isoprene-based compounds.

Within the meaning of the invention, the soft resin does not include oil containing naphthene groups.

Examples of suitable soft resins, without implying any limitation, are: Abitol E, Foralyn (Eastman), Granolite TEG, Dercolyte LTG, Dernastick 20 (DRT), Resiester T, Resiester T3 (Luresa), Abalyn®, Hercolyn® D, Hercolyn® DW, Pexoil® B (Pinova), sunflower oil, palm oil, soybean oil, corn oil. This list does not claim to be complete but may merely give the person skilled in the art examples of soft resins which can be used according to the invention.

The invention likewise provides a pressure-sensitive adhesive comprising (i) at least one synthetic rubber, (ii) at least one bio-based adhesive resin and/or adhesive resin mixture, (iii) at least one soft resin and/or soft resin mixture, wherein the total composition of the pressure-sensitive adhesive is 100% by weight (ad 100% by weight), optionally comprising additives, anti-ageing agents, fillers in an amount of from 0 to 5% by weight, preferably less than or equal to 1% by weight. The solids content of components (i), (ii) and (iii) can be less than or equal to 40% by weight, preferably the solids content of the pressure-sensitive adhesive is 40% by weight, in particular of the pressure-sensitive adhesive to be processed. The remaining proportion to 100% by weight can be solvents, which are preferably removed after processing so that the solids content of the resulting pressure-sensitive adhesive is from greater than or equal to 90% by weight to 100% by weight. Preferably, the solids content of the pressure-sensitive adhesive layer of the laminar pressure-sensitive adhesive medium is greater than or equal to 90% by weight, preferably greater than or equal to from 95 to 100% by weight, particularly preferably about 100% by weight. It is preferred, however, to use as little solvent as possible, solvent is preferably omitted completely (solventless pressure-sensitive adhesives). Hot melt processes are particularly suitable for the formulation and coating of the pressure-sensitive adhesives.

Further embodiments of the pressure-sensitive adhesive according to the invention, without implying any limitation, are

Pressure-sensitive adhesive A comprising
(i) at least one synthetic rubber based on at least one vinyl aromatic compound (A), preferably styrene, which has a content of from greater than or equal to 12% by weight to less than or equal to 30% by weight, preferably from greater than or equal to 12% by weight, in particular 13% by weight, 14% by weight, 15% by weight, 16% by weight, 17% by weight, 18% by weight, 19% by weight, to less than or equal to 20% by weight, from greater than or equal to 15% by weight to less than or equal to 20% by weight, particularly preferably from greater than or equal to 15% by weight to less than or equal to 19% by weight, based on all the synthetic rubbers, and at least one diene (B) according to structure (I) and/or structure (II), wherein R is a hydrogen or a linear, branched, ring-containing or cyclic and/or unsaturated hydrocarbon radical and preferably R is a hydrogen (isoprene) or C₁₀H₁₇ (a farnesene isomer, preferably from a biogenic source),
(ii) at least one bio-based adhesive resin and/or adhesive resin mixture which is based to the extent of greater than or equal to 85% by weight on renewable raw materials, has a softening point of greater than or equal to 80° C. and less than or equal to 110° C., preferably greater than or equal to 85° C. and less than or equal to 100° C., and is present in a proportion of the total composition of the pressure-sensitive adhesive of from greater than or equal to 35% by weight to less than or equal to 64% by weight, and
(iii) at least one bio-based soft resin and/or soft resin mixture which is based to the extent of greater than or equal to 85% by weight on renewable raw materials and is present in a proportion of the total composition of the pressure-sensitive adhesive of from greater than or equal to 1% by weight to less than or equal to 25% by weight, preferably from 2.5% by weight to 22% by weight, from 5% by weight to 15% by weight, particularly preferably the proportion of the at least one soft resin according to an alternative b) is from greater than or equal to 1% by weight to less than 10% by weight.

Optionally, the pressure-sensitive adhesive additionally comprises additives, anti-ageing agents, antioxidants, fillers of from 0 to 5% by weight, preferably from 0 to 1% by weight. The same applies to all pressure-sensitive adhesives according to the invention.

Pressure-sensitive adhesive B comprising
(i) at least one synthetic rubber based on at least one vinyl aromatic compound (A), preferably styrene, which has a content of from greater than or equal to 12% by weight to less than or equal to 30% by weight, preferably from greater than or equal to 12% by weight, in particular 13% by weight, 14% by weight, 15% by weight, 16% by weight, 17% by weight, 18% by weight, 19% by weight, to less than or equal to 20% by weight, from greater than or equal to 15% by weight to less than or equal to 20% by weight, particularly preferably from greater than or equal to 15% by weight to less than or equal to 19% by weight, based on all the synthetic rubbers, and at least one diene (B) according to structure (I) and/or structure (II), wherein R is a hydrogen or a linear, branched, ring-containing or cyclic and/or unsaturated hydrocarbon radical and preferably R is a hydrogen (isoprene) or C₁₀H₁₇ (a farnesene isomer, preferably from a biogenic source),
(ii) at least one bio-based adhesive resin and/or adhesive resin mixture which is based to the extent of greater than or equal to 85% by weight on renewable raw materials, has a softening point of greater than or equal to 80° C. and less than or equal to 110° C., preferably greater than or equal to 85° C. and less than or equal to 100° C., and is present in a proportion of the total composition of the pressure-sensitive adhesive of from greater than or equal to 40% by weight to less than or equal to 64% by weight, and
(iii) at least one bio-based soft resin and/or soft resin mixture which is based to the extent of greater than or equal to 85% by weight on renewable raw materials and is present in a proportion of the total composition of the pressure-sensitive adhesive of from greater than or equal to 1% by weight to less than or equal to 25% by weight, preferably from 2.5% by weight to 22% by weight, from 5% by weight to 15% by weight, particularly preferably the proportion of the at least one soft resin according to an alternative b) is from greater than or equal to 1% by weight to less than 10% by weight.

Pressure-sensitive adhesive C comprising
(i) at least one synthetic rubber based on at least one vinyl aromatic compound (A), preferably styrene, which has a content of from greater than or equal to 12% by weight to less than or equal to 30% by weight, preferably from greater than or equal to 12% by weight, in particular 13% by weight, 14% by weight, 15% by weight, 16% by weight, 17% by weight, 18% by weight, 19% by weight, to less than or equal to 20% by weight, from greater than or equal to 15% by weight to less than or equal to 20% by weight, particularly preferably from greater than or equal to 15% by weight to less than or equal to 19% by weight, based on all the synthetic rubbers, and at least one diene (B) according to structure (I) and/or structure (II), wherein R is a hydrogen or a linear, branched, ring-containing or cyclic and/or unsaturated hydrocarbon radical and preferably R is a hydrogen (isoprene) or C₁₀H₁₇ (a farnesene isomer, preferably from a biogenic source),
(ii) at least one bio-based adhesive resin and/or adhesive resin mixture which is based to the extent of greater than or equal to 85% by weight on renewable raw materials, has a softening point of greater than or equal to 80° C. and less than or equal to 110° C., preferably greater than or equal to 85° C. and less than or equal to 100° C., and is present in a proportion of the total composition of the pressure-sensitive adhesive of from greater than or equal to 50% by weight to less than or equal to 64% by weight, and
(iii) at least one bio-based soft resin and/or soft resin mixture which is based to the extent of greater than or equal to 85% by weight on renewable raw materials and is present in a proportion of the total composition of the pressure-sensitive adhesive of from greater than or equal to 1% by weight to less than or equal to 25% by weight, preferably from greater than or equal to 2.5% by weight to less than or equal to 22% by weight, particularly preferably according to an alternative a) in a proportion of from greater than or equal to 10% by weight to less than or equal to 25% by weight, preferably from greater than or equal to 15% by weight to less than or equal to 25% by weight, and preferably has a melt viscosity (according to test E) at 25° C. and 1 Hz of greater than or equal to 25 Pa*s, preferably greater than or equal to 50 Pa*s.

Pressure-sensitive adhesive D comprising
(i) at least one synthetic rubber based on at least one vinyl aromatic compound (A), preferably styrene, which has a content of from greater than or equal to 12% by weight to less than or equal to 30% by weight, preferably from greater than or equal to 12% by weight, in particular 13% by weight, 14% by weight, 15% by weight, 16% by weight, 17% by weight, 18% by weight, 19% by weight, to less than or equal to 20% by weight, from greater than or equal to 15% by weight to less than or equal to 20% by weight, particularly preferably from greater than or equal to 15% by weight to less than or equal to 19% by weight, based on all the synthetic rubbers, and at least one diene (B) according to structure (I) and/or structure (II), wherein R is a hydrogen or a linear, branched, ring-containing or cyclic and/or unsaturated hydrocarbon radical and preferably R is a hydrogen (isoprene) or C₁₀H₁₇ (a farnesene isomer, preferably from a biogenic source),
(ii) at least one bio-based adhesive resin and/or adhesive resin mixture which is based to the extent of greater than or equal to 85% by weight on renewable raw materials, has a softening point of greater than or equal to 80° C. and less than or equal to 110° C., preferably greater than or equal to 85° C. and less than or equal to 100° C., and is present in a proportion of the total composition of the pressure-sensitive adhesive of from greater than or equal to 35% by weight to less than or equal to 64% by weight, and
(iii) at least one bio-based soft resin and/or soft resin mixture which is based to the extent of greater than or equal to 85% by weight on renewable raw materials and is present in a proportion of the total composition of the pressure-sensitive adhesive of from greater than or equal to 1% by weight to less than or equal to 25% by weight, preferably from greater than or equal to 2.5% by weight to less than or equal to 22% by weight, particularly preferably according to an alternative a) is present in a proportion of from greater than or equal to 10% by weight to less than or equal to 25% by weight, preferably from greater than or equal to 15% by weight to less than or equal to 25% by weight, and preferably has a melt viscosity (according to test E) at 25° C. and 1 Hz of greater than or equal to 25 Pa*s, preferably greater than or equal to 50 Pa*s.

Pressure-sensitive adhesive E comprising
(i) at least one synthetic rubber based on at least one vinyl aromatic compound (A), preferably styrene, which has a content of from greater than or equal to 15% by weight to less than or equal to 20% by weight, particularly preferably from greater than or equal to 15% by weight to less than or equal to 19% by weight, based on all the synthetic rubbers, and at least one diene (B) according to structure (I) and/or structure (II), wherein R is a hydrogen or a linear, branched, ring-containing or cyclic and/or unsaturated hydrocarbon radical and preferably R is a hydrogen (isoprene) or C₁₀H₁₇ (a farnesene isomer, preferably from a biogenic source),
(ii) at least one bio-based adhesive resin and/or adhesive resin mixture which is based to the extent of greater than or equal to 85% by weight on renewable raw materials, has a softening point of greater than or equal to 80° C. and less than or equal to 110° C., preferably greater than or equal to 85° C. and less than or equal to 100° C., and is present in a proportion of the total composition of the pressure-sensitive adhesive of from greater than or equal to 35% by weight to less than or equal to 64% by weight, and
(iii) at least one bio-based soft resin and/or soft resin mixture which is based to the extent of greater than or equal to 85% by weight on renewable raw materials and is present in a proportion of the total composition of the pressure-sensitive adhesive of from greater than or equal to 1% by weight to less than or equal to 25% by weight, preferably from greater than or equal to 2.5% by weight to less than or equal to 22% by weight, particularly preferably according to an alternative a) is present in a proportion of from greater than or equal to 10% by weight to less than or equal to 25% by weight, preferably from greater than or equal to 15% by weight to less than or equal to 25% by weight, and has a melt viscosity (according to test E) at 25° C. and 1 Hz of greater than or equal to 50 Pa*s.

Pressure-sensitive adhesive F comprising
(i) at least one synthetic rubber based on at least one vinyl aromatic compound (A), preferably styrene, which has a content of from greater than or equal to 15% by weight to less than or equal to 20% by weight, particularly preferably from greater than or equal to 15% by weight to less than or equal to 19% by weight, based on all the synthetic rubbers, and at least one diene (B) according to structure (I) and/or structure (II), wherein R is a hydrogen or a linear, branched, ring-containing or cyclic and/or unsaturated hydrocarbon radical and preferably R is a hydrogen (isoprene) or C₁₀H₁₇ (a farnesene isomer, preferably from a biogenic source),
(ii) at least one bio-based adhesive resin and/or adhesive resin mixture which is based to the extent of greater than or equal to 85% by weight on renewable raw materials, has a softening point of greater than or equal to 80° C. and less than or equal to 110° C., preferably greater than or equal to 85° C. and less than or equal to 100° C., and is present in a proportion of the total composition of the pressure-sensitive adhesive of from greater than or equal to 40% by weight to less than or equal to 64% by weight, and
(iii) at least one bio-based soft resin and/or soft resin mixture which is based to the extent of greater than or equal to 85% by weight on renewable raw materials and is present in a proportion of the total composition of the pressure-sensitive adhesive of from greater than or equal to 1% by weight to less than or equal to 25% by weight, preferably from greater than or equal to 2.5% by weight to less than or equal to 22% by weight, from greater than or equal to 5% by weight to less than or equal to 15% by weight, particularly preferably according to an alternative b) in a proportion of from greater than or equal to 1% by weight to less than or equal to 10% by weight, in particular the at least one soft resin has a melt viscosity (according to test E) at 1 Hz and 25° C. of less than or equal to 25 Pa*s.

The solids content of all the pressure-sensitive adhesives according to the invention before processing is at least 40% by weight, wherein the solvent content in this case is 60% by weight. After processing, the solvents, all of which are preferably highly volatile, evaporate. At least some of the solvents used are likewise bio-based. The invention also provides a solventless pressure-sensitive adhesive, in which the proportion of solvents, in particular at the time of formulation and coating, is less than 2% by weight.

The present invention further provides a pressure-sensitive adhesive which has a solvent content of less than or equal to 70% by weight, preferably less than or equal to 50% by weight, especially less than or equal to 40% by weight, particular preference is given to a solventless hot melt adhesive.

Solvents include organic polar solvents such as acetone, butanone and other ketones and ethyl acetate, butyl acetate and other esters and/or organic non-polar solvents, such as alkanes, petroleum ether and/or organic aromatic solvents such as toluene and xylene.

In an alternative, the pressure-sensitive adhesive is preferably processed in the form of a melt and thus solventless, including the production of the formulation of the pressure-sensitive adhesive as well as of the laminar pressure-sensitive adhesive medium. Solventless processing additionally lowers the carbon dioxide emissions and is therefore particularly advantageous. Examples of elastomers which can be used in pressure-sensitive adhesives according to the present invention are compiled in Table 1.

It can be necessary to add additives to the above formulation of the pressure-sensitive adhesive. Fillers are conventionally added in order to increase the cohesion of a pressure-sensitive adhesive, but also to increase the weight and/or the volume. There can be added in particular synthetic elastomers, fillers for improving the hardness, strength, resilience and expansion. Typical fillers are carbonates, in particular calcium carbonate, and silicates (talc, clay, mica), diatomaceous earth, calcium and barium sulfate, aluminum hydroxide, glass fibers and glass beads, as well as carbon blacks. Further possible additives are plasticizers, accelerators and/or photoinitiators according to the prior art. In a particular embodiment, the pressure-sensitive adhesive comprises rheology additives. In a preferred embodiment, the pressure-sensitive adhesive does not comprise additives, in particular the addition of additives to increase the quality of the pressure-sensitive adhesive, in particular the cohesion in the pressure-sensitive adhesive according to the invention, is not necessary.

As additives to the adhesive there are typically used primary antioxidants, such as, for example, sterically hindered phenols, secondary antioxidants, such as, for example, phosphites or thioethers, and light stabilizers, such as, for example, UV absorbers or sterically hindered amines.

As reinforcing and non-reinforcing fillers there may be mentioned especially silicon dioxides (spherical, needle-shaped or irregular, such as pyrogenic silicas), calcium carbonates, zinc oxides, titanium dioxides, aluminum oxides or aluminum oxide hydroxides. However, it is pointed out here that the listed substances are not essential and the adhesive functions even without the addition of these substances individually or in an arbitrary combination, that is to say without fillers and/or dyes and/or anti-ageing agents.

As bio-based or organic fillers there can be used both in particular vegetable as well as animal raw materials, optionally also in combination with one another. Lamellar fillers such as layered silicates are also suitable. The organic fillers are very preferably in finely divided form, in particular in the form of fibers, pellets, dust or powder. As vegetable organic fillers there are chosen preferably renewable raw materials (renewable organic materials), in particular wood, cork, hemp, flax, grasses, reeds, straw, hay, cereals, maize, nuts or constituents of the above-mentioned materials, such as shells (for example nut shells), kernels, beards or the like. There are used in particular wood flours, cork flours, cereal flours, corn flours and/or potato flours, without implying any unnecessary limitation of the inventive teaching. Animal organic fillers that are advantageously used are in particular bones, chitin (for example crab shells, insect shells), hair, bristles and horn, in particular in finely divided (ground) form. Preference is given to the use of cellulose powders such as wood flour as filler.

The pressure-sensitive adhesive according to the invention can be produced by the compounding process. The pressure-sensitive adhesive according to the invention can be produced using solvents in solvent kneaders or, for example, also by using high-speed dispensers. However, such formulations are preferably produced without a solvent. There are suitable for this purpose kneaders for batchwise operation and extruders such as, for example, twin-screw extruders or planetary-gear extruders for continuous operation. Suitable compounding units within the meaning of this invention are those which contain dispersive and optionally distributive mixing elements. Dispersive mixing elements ensure that the filler particles that are optionally present are distributed as finely as possible in the formulation, while distributive elements homogenize molten constituents, such as resins or polymers, in the mixture of the pressure-sensitive adhesive formulation. In solventless batchwise operation, Banbury mixers or BUSS co-kneaders are particularly suitable. BUSS co-kneaders belong to the single-shaft screw machines. The screw shaft executes a synchronous to and fro movement in the axial direction per revolution. This sinusoidal movement sequence is made possible by a special gear.

The characteristic kneading blades on the screw shaft cooperate with fixed kneading teeth or pins in the kneader housing. The raw material components are thereby sheared over an unusually short process length between the kneading blades and the kneading teeth. The oscillating screw shaft additionally ensures intensive product exchange in the axial direction by repeatedly dividing, folding and reorienting the kneaded mass.

This specific working principle also yields an outstanding distributive mixing action through optimum distribution of the starting materials. This comes to bear in particular when the melt viscosities and ranges of the components of the formulation are very different, when liquid components have to be incorporated, or when high proportions of fibers or fillers are to be mixed in.

The dispersive mixing effect differs significantly from other systems. There are no product-damaging pressure peaks and no high radial pressures. The matrix is relaxed after each shear cycle by moving into the adjacent channels, in order to be divided, folded and reoriented again before the next shear cycle takes place. Noteworthy is the extremely short process length, the narrow dwell time spectrum and the comparatively deep product-temperature profile. The co-kneader system is additionally distinguished by a high self-cleaning effect.

The Banbury mixer has become a generic term for a very specific type of intimate mixer. The mixer has a closed chamber in which there rotate two rotors equipped with kneading elements (see reference book “Thermoplastic and Rubber Compounds” by White and Kim; chapter (Banbury; pages 234 to 245), Carl Hanser Verlag, Munich, 2008).

In continuous operation, twin-screw extruders in co-rotating mode can preferably be used.

The invention likewise provides pressure-sensitive adhesives obtainable by a process described above, and the use of the pressure-sensitive adhesive for the production of pressure-sensitive adhesive layers, including laminar pressure-sensitive adhesive media.

Preferred embodiments of the invention include laminar pressure-sensitive adhesive media comprising the above-described composition of the pressure-sensitive adhesive and/or hot melt adhesive according to the invention. Preferred embodiments are described below, without implying any limitation.

I. Laminar pressure-sensitive adhesive medium comprising at least one pressure-sensitive adhesive layer having a weight per unit area of at least 70 g/m², in particular at least 100 g/m², preferably at least 250 g/m², comprising the following composition of the pressure-sensitive adhesive:
(i) at least one synthetic rubber, wherein the synthetic rubber is based on the monomers A and B, preferably on styrene and at least on a diene according to formula (I) and/or formula (II), wherein R is a hydrogen or a linear, branched, ring-containing or cyclic and/or unsaturated hydrocarbon radical and preferably R is a hydrogen (isoprene) or C₁₀H₁₇ (a farnesene isomer, preferably from a biogenic source), and the proportion of all the synthetic rubbers is less than or equal to 45% by weight of the total composition of the pressure-sensitive adhesive (ad 100% by weight), preferably less than or equal to 35% by weight of the total composition of the pressure-sensitive adhesive (ad 100% by weight), the proportion of A (preferably proportion of styrene) of at least one synthetic rubber is from greater than or equal to 12% by weight to less than or equal to 30% by weight, preferably from greater than or equal to 12% by weight to less than or equal to 20% by weight, from greater than or equal to 15% by weight to less than or equal to 20% by weight, particularly preferably from greater than or equal to 15% by weight to less than or equal to 19% by weight, at least one type of triblock copolymer having the structure A-B-A is present, and the proportion of triblock copolymer, based on all the synthetic rubbers used, is at least 60% by weight,
(ii) at least one adhesive resin and/or adhesive resin mixture based to the extent of greater than or equal to 85% by weight, preferably to the extent of 100% by weight, on renewable raw materials, wherein the adhesive resin and/or adhesive resin mixture has a softening temperature of greater than or equal to 80° C. and less than or equal to 110° C. and the proportion thereof is greater than or equal to 40% by weight of the total composition of the pressure-sensitive adhesive (ad 100% by weight), preferably greater than or equal to 50% by weight of the total composition of the pressure-sensitive adhesive (ad 100% by weight), and
(iii) at least one soft resin and/or soft resin mixture based to the extent of greater than or equal to 85% by weight, preferably to the extent of 100% by weight, on renewable raw materials, wherein the proportion thereof according to alternative b) is from greater than or equal to 1% by weight to less than or equal to 10% by weight of the total composition of the pressure-sensitive adhesive (ad 100% by weight). The at least one soft resin can in particular have a melt viscosity (according to test E) at 1 Hz and 25° C. of less than or equal to 25 Pa*s.

II. Laminar pressure-sensitive adhesive medium comprising at least one pressure-sensitive adhesive layer having a weight per unit area of at least 70 g/m², in particular at least 100 g/m², preferably at least 250 g/m², comprising the following composition of the pressure-sensitive adhesive:
(i) at least one synthetic rubber, wherein the synthetic rubber comprises as monomers A and B preferably styrene and at least one diene according to structure (I) and/or structure (II), wherein R is a hydrogen or a linear, branched, ring-containing or cyclic and/or unsaturated hydrocarbon radical and preferably R is a hydrogen (isoprene) or C₁₀H₁₇ (a farnesene isomer, preferably from a biogenic source), and the proportion of all the synthetic rubbers is less than or equal to 45% by weight of the total composition of the pressure-sensitive adhesive (ad 100% by weight), preferably less than or equal to 35% by weight of the total composition of the pressure-sensitive adhesive (ad 100% by weight), the proportion of A (preferably proportion of styrene) of at least one synthetic rubber is from greater than or equal to 12% by weight to less than or equal to 30% by weight, preferably from greater than or equal to 12% by weight to less than or equal to 20% by weight, from greater than or equal to 15% by weight to less than or equal to 20% by weight, particularly preferably from greater than or equal to 15% by weight to less than or equal to 19% by weight, at least one type of triblock copolymer having the structure A-B-A is present, and the proportion of triblock copolymer, based on all the synthetic rubbers used, is at least 60% by weight,
(ii) at least one adhesive resin and/or adhesive resin mixture based to the extent of greater than or equal to 85% by weight, preferably to the extent of 100% by weight, on renewable raw materials, wherein the adhesive resin and/or adhesive resin mixture has a softening temperature of greater than or equal to 80° C. and less than or equal to 110° C. and the proportion thereof is greater than or equal to 40% by weight of the total composition of the pressure-sensitive adhesive (ad 100% by weight), preferably greater than or equal to 50% by weight of the total composition of the pressure-sensitive adhesive (ad 100% by weight), and
(iii) at least one soft resin and/or soft resin mixture based to the extent of greater than or equal to 85% by weight, preferably to the extent of 100% by weight, on renewable raw materials, wherein according to alternative a) the proportion thereof is from greater than or equal to 10% by weight to 25% by weight of the total composition of the pressure-sensitive adhesive (ad 100% by weight) and at least one soft resin has a melt viscosity according to test E at 25° C. and 1 Hz of at least 25 Pa*s, preferably of at least 50 Pa*s.

It can be seen that, as the melt viscosity of the soft resin increases, the proportion of elastomers, at a given triblock/diblock ratio, can be reduced. The proportion of biogenic raw materials can accordingly be optimized (increased).

The invention likewise provides a laminar pressure-sensitive adhesive medium comprising a pressure-sensitive adhesive according to the invention, wherein the pressure-sensitive adhesive is present in the form of at least one or more layers having a total weight per unit area of from greater than or equal to 70 g/m² in particular to less than or equal to 1000 g/m², preferably from greater than or equal to 100 g/m² to less than or equal to 750 g/m², particularly preferably from greater than or equal to 250 g/m² to less than or equal to 500 g/m², preferably with a margin of deviation of in each case plus/minus 10%.

Preferably, the laminar pressure-sensitive adhesive medium, in particular in the form of an adhesive tape, comprises one or more pressure-sensitive adhesive layers, the at least one pressure-sensitive adhesive layer has with a weight per unit area of at least 70 g/m², preferably at least 100 g/m², very preferably of at least 250 g/m², and the at least one pressure-sensitive adhesive layer is arranged on a laminar element. The laminar pressure-sensitive adhesive medium can optionally have a second laminar element.

For the laminar pressure-sensitive adhesive medium according to the invention, preference is given to at least one laminar element selected from laminar elements comprising spun, woven and/or molten laminar elements, such as nonwovens, films, woven fabrics, mesh fabrics, nets, textiles and textile tapes. The laminar element is preferably a carrier, a film or a detachable laminar element such as a release liner, transfer material and/or covering material. Arrangements comprising at least two of the above-mentioned laminar elements are further in accordance with the invention. The laminar element is preferably a textile carrier, preferably a woven fabric, in particular a polyester woven fabric, a nonwoven or knitted fabric or combinations thereof. In particular embodiments of the invention where increased demands are made of the stability of the laminar element, the above-mentioned structures can be combined with filament structures comprising spun, woven and/or molten fibers, yarns, knitted fabrics, meshwork, interlaced yarns and filaments. Nets and fibers arranged in a diamond shape are particularly suitable. Elastomeric and viscoelastic foams with different densities (for example from 100 kg/m³ to 900 kg/m³) are additionally conceivable. In a further embodiment, the laminar element is produced from bio-based materials, preferably from polylactic acid, polyethylene produced from biogenic ethylene, polyethylene furanoate, cellulose and cotton. The bio content of this laminar element is preferably at least 85%, particularly preferably 100%.

Release liners are typically not used in every variant of this invention in the case of adhesive tapes coated on one or both sides with adhesives, in order to prevent the pressure-sensitive adhesives from coming into contact with each other or being contaminated before use or in order to be able to unroll an adhesive tape with the desired force (light or heavy). In the case of single-sided adhesive tapes, a covering material or release material on the adhesive can ensure easier unrolling. Liners, in particular of the bio-based polymer, in particular polyester, are also used to cover labels. In the case of adhesive tapes coated on both sides with adhesive, the release liners additionally ensure that the correct side of the adhesive is exposed first upon unrolling. A liner or release liner (release paper, release film) is not a constituent of an adhesive tape or label but merely an aid to its production, storage, or for further processing by punching. Moreover, a liner, in contrast to an adhesive tape carrier, is not firmly bonded to an adhesive layer. Preference is given to the use of release liners based on paper or based on films of biogenic raw materials such as, in particular, polylactic acid, polyethylene based on biogenic ethylene, or polyethylene furanoate.

A covering material serves in particular to cover the pressure-sensitive adhesive applied to one and/or both sides until it is used, and/or the transfer material serves in particular to facilitate handling of the adhesive tape, inter alia to make the adhesive tape easier to roll up and unroll.

The present invention likewise provides a laminar pressure-sensitive adhesive medium having an adhesive force according to test A on steel of greater than or equal to 10 N/cm, in particular greater than 11 N/cm, 12 N/cm, 13 N/cm, 14 N/cm, particularly preferably greater than 15 N/cm, optionally to less than or equal to 17 N/cm, preferably of greater than or equal to 11 N/cm, optionally to less than or equal to 16.5 N/cm, preferably of greater than or equal to 12 N/cm, optionally to less than or equal to 16 N/cm, and having an adhesive force according to test A on polyethylene (PE) of greater than or equal to 5 N/cm, preferably less than or greater than or equal to 6 N/cm, 7 N/cm, 8 N/cm, optionally to less than or equal to 10 N/cm, preferably from greater than or equal to 5 N/cm to less than or equal to 9 N/cm, preferably from greater than or equal to 5 N/cm optionally to less than or equal to 8 N/cm.

The statements made in relation to the adhesive force on steel preferably also apply to bonding to other metallic materials such as cast iron and non-ferrous materials, such as pure metals and alloys of the mentioned materials. The statements made in relation to the adhesive force on PE preferably also apply to bonding to other materials having low-energy surfaces. These include aliphatic, olefinic and/or aromatic polymers, in particular polyesters. Preference is given to aliphatic polymers comprising carboxylic acid esters, in particular polymers selected from the group comprising polyethylene, low-density polyethylene (LDPE) and high-density polyethylene (HDPE), polystyrene and further polymers known in the art. Polyethylene (PE) and polyethylene terephthalate (PET) are particularly preferred.

In a further embodiment, the laminar pressure-sensitive adhesive medium has a shear adhesion according to test B of greater than or equal to 2500 min, especially greater than or equal to 5000 min, preferably greater than or equal to 8000 min or even greater than or equal to 10,000 min.

The present invention likewise provides a laminar pressure-sensitive adhesive medium in which the bio-based or biogenic proportion (calculated as specified in Example 4) in the pressure-sensitive adhesive, based on the total composition, is at least 40% by weight, preferably at least 50% by weight, particularly preferably at least 60% by weight. Preferably in relation to the solids content of the laminar pressure-sensitive adhesive after evaporation of the solvents or after cooling of the hot melt pressure-sensitive adhesive in the laminar pressure-sensitive adhesive medium.

The present invention further provides that the laminar pressure-sensitive adhesive medium is a single- or double-sided self-adhesive tape, self-adhesive label, self-adhesive film and/or punched blank.

Within the meaning of this invention, the general expression “adhesive tape” includes all laminar structures, such as films or film portions that extend in two dimensions, tapes having an extended length and limited width, tape portions and the like, finally also punched blanks or labels.

The adhesive tape can be produced in the form of a roll, that is to say in the form of an Archimedean spiral rolled up on itself. A reverse-face coating material can be applied to the reverse face of the adhesive tape in order advantageously to influence the unrolling properties of the adhesive tape wound into an Archimedean spiral. To that end, the reverse-face coating material can be provided with silicone or fluorosilicone compounds as well as with polyvinylstearyl carbamate, polyethyleneinninestearylcarbannide or organofluorine compounds as substances having a non-stick action.

The single- or double-sided adhesive tape is preferably selected from the group comprising self-adhesive products, single-sided adhesive tapes (fabric adhesive tapes), carpet-laying tapes, adhesive mounting tapes, adhesive masking tapes, transfer tapes, adhesive insulating tapes and surface-protection films.

Products in which these adhesives can advantageously be utilized are those in which the adhesion requirements are high. Single- and double-sided adhesive products are suitable. As a single-sided adhesive tape there may be mentioned a duct tape (see, for example, U.S. Pat. No. 5,271,999 A), consisting of a PE carrier (for example based on biogenic PE from Braskem, provided with a release on the reverse face), a laminating adhesive (for example 10 g/m²) of adhesive according to the invention, a fabric (for example of cotton or recycled PET) and a layer of adhesive according to the invention (for example 90 g/m²). A double-sided adhesive product can be a carpet-laying tape (see, for example, EP 1 117 746 B1), having a first layer of an adhesive according to the invention (for example 30 g/m²), a carrier film (for example BOPP, recycled PP or polylactic acid), a second layer of an adhesive according to the invention (for example 80 g/m²) and a double-sided graduated siliconized release paper (glassine paper or recycled paper). A further double-sided adhesive product can be an adhesive mounting tape having a layer of an adhesive according to the invention (150 g/m²) on a double-sided graduated siliconized release paper (glassine paper or recycled paper).

In a further variant of the invention, the total weight per unit area of pressure-sensitive adhesive layers according to the invention in the products, that is to say the sum of the individual weights per unit area of all the pressure-sensitive adhesive layers according to the invention in the products, is at least 70 g/m², in particular at least 100 g/m², preferably at least 250 g/m². In order to achieve a total weight per unit area of at least 70 g/m², at least 100 g/m² or at least 250 g/m², individual, a plurality or all of the pressure-sensitive adhesive layers can have a weight per unit area of less than or equal to 70 g/m², preferably at least 40 g/m².

The invention likewise provides a process for the production of a laminar pressure-sensitive adhesive medium according to the invention, wherein the laminar pressure-sensitive adhesive medium is formed from the pressure-sensitive adhesive according to the invention into at least one layer having a weight per unit area of at least 70 g/m², in particular at least 100 g/m² or of at least 250 g/m².

In a further embodiment of the process according to the invention, the laminar pressure-sensitive adhesive medium is formed by
melting the pressure-sensitive adhesive according to the invention,
applying the pressure-sensitive adhesive according to the invention to a substrate, wherein the pressure-sensitive adhesive is applied in at least one layer having a weight per unit area of greater than or equal to 70 g/m², greater than or equal to 100 g/m² or greater than or equal to 250 g/m², and
the pressure-sensitive adhesive layer is cooled, and
a laminar pressure-sensitive adhesive medium according to the present invention is obtained.

In a further embodiment of the process according to the invention, the laminar pressure-sensitive adhesive medium is formed by
producing the pressure-sensitive adhesive according to the invention in solvent,
applying the pressure-sensitive adhesive according to the invention to a substrate, wherein the pressure-sensitive adhesive is applied in at least one layer having a weight per unit area after drying of greater than or equal to 70 g/m², greater than or equal to 100 g/m² or greater than or equal to 250 g/m², and
the pressure-sensitive adhesive layer is dried of solvent, and
a laminar pressure-sensitive adhesive medium according to the present invention is obtained.

A further aspect of the invention relates to a process for the production of a laminar pressure-sensitive adhesive medium having a weight per unit area of less than 70 g/m² or at least 70 g/m² and subsequent inline or offline production of a second laminar pressure-sensitive adhesive medium, which is associated with the first laminar pressure-sensitive adhesive medium directly (in contact) or indirectly (separated by at least one laminar element), having a weight per unit area of less than 70 g/m² or at least 70 g/m², so that products having a total weight per unit area of at least 70 g/m², at least 100 g/m² or at least 250 g/m² are obtained.

In the process according to the invention, the substrate is preferably a laminar element, in particular a carrier material, film, release liner, transfer material and/or covering material. Substrates can also be the surfaces of the manufacturing line in the production process. A weight per unit area of the pressure-sensitive adhesive of the to at least one pressure-sensitive adhesive layer of greater than or equal to 70 g/m² is thereby processed, greater than or equal to 100 g/m² or greater than or equal to 250 g/m² or also less than 70 g/m², and the pressure-sensitive adhesive layer applied in a laminar manner is optionally dried, or the solvents are removed. A solventless hot melt adhesive is preferably processed.

In particular, in order to produce a double-sided laminar pressure-sensitive adhesive medium in the process according to the invention, a pressure-sensitive adhesive is likewise applied to the second surface of the laminar element with a weight per unit area of greater than or equal to 70 g/m², at least 100 g/m² or at least 250 g/m² or also less than 70 g/m², preferably greater than or equal to 70 g/m², and a further laminar element in the form of a transfer layer/cover layer/barrier layer is optionally applied to the second surface of the laminar pressure-sensitive adhesive medium having the pressure-sensitive adhesive layer. In a further embodiment of the process, the single-sided laminar pressure-sensitive adhesive medium is covered with a second laminar element in the form of a transfer material and/or covering material. A second laminar element is used in the case of punched blanks and/or labels in particular, in order to prevent contamination before use.

For the application of the pressure-sensitive adhesive there can be used as the coating process for the laminar elements used according to the invention inter alia knife processes, knife die processes, roll rod die processes, extrusion die processes, casting die processes and pourer processes. Likewise in accordance with the invention are application processes such as roller application processes, printing processes, screen printing processes, anilox roll processes, inkjet processes and spraying processes. Preference is given to hot melt processes (extrusion, die).

In a further embodiment of the process according to the invention, the resulting combination of laminar element and pressure-sensitive adhesive is cut into bulk goods including tapes, and/or punched blanks are punched out and the tapes are optionally rolled up into a banderole.

The present invention further provides adhesive tapes, in particular self-adhesive products and high-performance adhesive tapes, which are obtainable by the above-described processes. The invention likewise provides the use of a pressure-sensitive adhesive according to the invention, of a laminar pressure-sensitive adhesive medium according to the invention and of the process product according to the invention to form barrier layers and for sheathing elongated goods such as electric lines including cables, cable sets and/or wires. Particular preference is given to the sheathing of elongate goods in automotive interior applications according to LV-312.

In particular, the invention covers the use as self-adhesive products, single-sided adhesive tapes and double-sided adhesive tapes, such as fabric adhesive tape, adhesive repair tape, duct tape, adhesive foam tape for heat insulation or for sealing applications, carpet-laying tape, adhesive mounting tapes, adhesive masking tapes, transfer tapes, surface-protection films, punched blanks and labels.

TABLE 1
Examples of advantageous synthetic rubbers for the pressure-sensitive adhesive
composition according to the invention

| | | | Styrene | | Melt index |
|---|---|---|---|---|---|
| | | | content | Diblock | [g/10 min] |
| | | | [% by | proportion [% | A: (200° C./5 kg) |
| Manufacturer | Nature | Type | weight] | by weight] | B: (190° C./5 kg) |
| Kraton | SIS linear | D111 | 22 | 18 | A: 3 |
| | SIS linear | D1113 | 16 | 55 | A: 24 |
| | SIS linear | D1114 | 19 | <1 | A: 9 |
| | SIS linear | D1117 | 17 | 33 | A: 33 |
| | SIS linear | D1119 | 22 | 66 | A: 25 |
| | SIS radial | D1124 | 30 | 30 | A: 4 |
| | SIS radial | D1126 | 19 | 30 | A: 15 |
| | SIS linear | D1161 | 15 | 19 | A: 12 |
| | SIS linear | D1163 | 15 | <1 | A: 22 |
| | SIS linear | D1164 | 29 | <1 | A: 12 |
| | SIS linear | D1165 | 30 | 20 | A: 7 |
| | SIS linear | D1183 | 16 | 38 | A: 14 |
| | SIS linear | D1193 | 24 | 20 | A: 14 |
| | SIBS linear | D1170 | 19 | 27 | A: 13 |
| | SIBS linear | D1171 | 20 | 26 | A: 11 |
| | SIBS linear | D1173 | 18 | 60 | A: 14 |
| TRSC | SIS linear | Taipol 1307 | 16 | 18 | B: 8 |
| Corporation | SIS linear | Taipol 1308 | 16 | 44 | B: 23 |
| | SIS linear | Taipol 2311 | 18 | <1 | B: 11 |
| | SIS linear | Taipol 2393 | 25 | 24 | B: 9 |
| | SIS linear | Taipol 2411 | 30 | <1 | B: 9 |
| Polymeri | SIS linear | Europrene | 16 | 25 | B: 9 |
| Europa | | Sol T190 | | | |
| | SIS linear | Europrene | 25 | 20 | B: 3 |
| | | Sol T193A | | | |
| | SIS linear | Europrene | 25 | 20 | B: 8 |
| | | Sol T193B | | | |
| | SIS linear | Europrene | 18 | 8 | B: 12 |
| | | Sol T9113 | | | |
| | SIS linear | Europrene | 16 | 55 | B: 16 |
| | | Sol TE9133 | | | |
| | SIS radial | Europrene | 20 | 30 | B: 8 |
| | | Sol TE9232 | | | |
| | SIS linear | Europrene | 30 | 20 | B: 8 |
| | | Sol TE9326 | | | |
| | SIS linear | Europrene | 15 | 40 | B: 15 |
| | | Sol TE9131 | | | |
| DEXCO | SIS linear | Vector | 18 | <1 | A: 12 |
| Polymers | | 4111A | | | |
| | SIS linear | Vector | 15 | 18 | A: 10 |
| | | 4113(A) | | | |
| | SIS linear | Vector | 15 | 42 | A: 25 |
| | | 4114(A) | | | |
| | SIS radial | Vector | 18 | 73 | A: 23 |
| | | 4186A | | | |
| | SIS linear | Vector | 30 | <1 | A: 13 |
| | | 4211(A) | | | |
| | SIS linear | Vector | 25 | 25 | A: 12 |
| | | 4213A | | | |
| | SIS linear | Vector | 30 | 18 | A: 9 |
| | | 4215A | | | |
| | SIS radial | Vector 4230 | 20 | 30 | A: 14 |
| | SIS radial | Vector | 30 | 24 | A: 11 |
| | | 4293A | | | |
| Zeon | SIS linear | Quintac | 14 | 26 | A: 10 |
| Chemicals LP | | 3421 | | | |
| | SIS linear/ | Quintac | 14 | 12 | A: 9 |
| | SIS radial | 3620 | | | |
| | SIS linear | Quintac | 16 | 56 | A: 12 |
| | | 3433N | | | |
| | SIS linear | Quintac | 15 | 78 | A: 7 |
| | | 3520 | | | |
| | SIS radial | Quintac | 19 | 30 | A: 15 |
| | | 3450 | | | |
| | SIS linear | Quintac | 25 | 19 | A: 11 |
| | | 3460 | | | |
| | SIS linear | Quintac | 25 | 42 | A: 11 |
| | | 3280 | | | |

The invention will be explained in greater detail by means of the following examples, without limiting it to the disclosure of the examples.

### Assessment Criteria

The criteria for a laminar pressure-sensitive adhesive medium that is suitable for use are
adhesive force on steel (test A—steel)
adhesive force on non-polar surface, in particular PE (test A—PE)
shear adhesion (test B)
biogenic proportion (calculation as specified in Example 4)

### Test Methods

Unless indicated otherwise, the measurements are carried out in a test climate of 23±1° C. and 50±5% relative humidity.

### Test A: Measurement of Adhesive Force

In order to determine the adhesive force (peel strength) on steel, the following procedure, based on PSTC-1, is used: A 70 g/m² thick pressure-sensitive adhesive layer is applied to a 36 μm thick PET film with an etched surface. A 2 cm wide and 15 cm long strip of this specimen is adhesively bonded to a ground steel plate by double rolling five times by means of a 5 kg roller. The plate is clamped and the self-adhesive strip is detached via its free end on a tensile tester at a peel angle of 180° at a rate of 300 mm/min. The results are given in N/cm.

In order to determine the adhesive force on polyethylene (PE), an analogous procedure is followed, except that measurement is made on a PE substrate (HDPE) instead of a steel substrate.

### Test B: Measurement of Shear Adhesion

The test is carried out, based on PSTC-7, at 23° C. using a weight of 1 kg. A 70 g/cm² thick pressure-sensitive adhesive layer is applied to a 36 μm thick PET film with an etched surface. A 1.3 cm wide strip of this specimen is adhesively bonded to a polished steel plate over a length of 2 cm by double rolling twice with a 1 kg roller. The plates are equilibrated for 30 minutes under test conditions (23° C. temperature and 50% relative humidity), but without a load. The test weight (1 kg) is then suspended so that a shear stress parallel to the bond face is produced, and the time to failure of the bond is measured. The results are given in minutes and, in the case of failure, the mode of failure is indicated (cohesive failure or adhesive failure).

### Test C: Resin Softening Temperature

Resin softening temperatures were determined by the ring and ball principle analogously to ASTM D36 using a HRB 754 softening point tester from Herzog.

### Test D: Glass Transition Temperature of Synthetic Rubber Blocks

The glass transition temperature of polymer blocks in block copolymers was determined by means of differential scanning calorimetry (DSC). To that end, approximately 5 mg of the untreated block copolymer samples were weighed into an aluminum crucible (volume 25 μl) and covered with a perforated lid. For the measurement, a DSC 204 F1 from Netzsch was used and the procedure was carried out under nitrogen for inertization. The sample was first cooled to −150° C., heated to +150° C. at a heating rate of 10 K/min and cooled to −150° C. again. The subsequent second heating curve was again conducted at 10 K/min, and the change in the heat capacity was recorded. Glass transitions are recognized as steps in the thermogram.

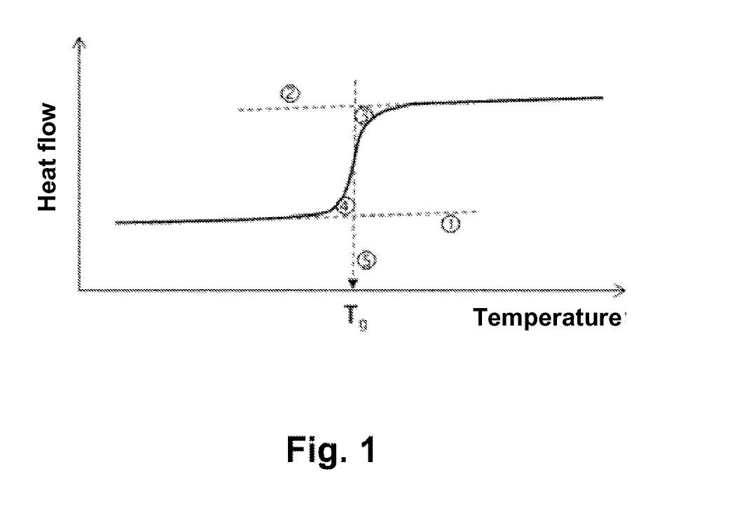

The glass transition temperature is evaluated as follows (see FIG. 1):

A tangent is applied to the base line of the thermogram before \textcircled{1} and after \textcircled{2} the step. In the region of the step, a best-fit line \textcircled{5} is placed parallel to the ordinate so that it cuts the two tangents in such a manner that two areas \textcircled{3} and \textcircled{4} (in each case between a tangent, the best-fit line and the measurement curve) of equal size are formed. The point of intersection of the best-fit curve so positioned with the measurement curve gives the glass transition temperature.

### Test E: Viscosity of the Soft Resins

In order to determine the melt viscosity of the soft resins, a shear stress sweep was carried out in rotation in a shear-stress-regulated DSR 200 N rheometer from Rheometrics Scientific. A cone/plate measuring system having a diameter of 25 mm (cone angle 0.1002 rad) was used, the measuring head was air-mounted and suitable for normal force measurements. The gap was 0.053 mm and the measuring temperature was 25° C. The frequency was varied from 0.002 Hz to 200 Hz and the melt viscosity was recorded at 1 Hz.

### Example of the Production of a Laminar Pressure-Sensitive Adhesive Medium:

### (a) Solvent-Based

The weighed formulation constituents were placed in a sample vial, and the calculated amount of solvent was added. The mixture was rotated on a roller bench for 18 hours. A homogeneous solution formed. The adhesive solution was spread by means of a comma blade on a siliconized release paper on a laboratory coating table. The coatings were then pre-dried for 30 minutes at room temperature and finally dried for 15 minutes at 120° C. The open side of the pressure-sensitive adhesive layer was covered with a layer of an etched 36 μm thick polyester film. This method was used for Examples 1 to 5.

### (b) Solventless

All the kneading compositions were produced in a heatable 2-liter double-sigma kneader from Aachener Maschinenbau Küpper type III-P1. The jacket of the kneader was heated by means of a thermal oil heating bath from Lauda. A bath temperature of 190° C. (which corresponds to an internal temperature of about 140° C.) was established. Throughout the kneading operation, a CO₂ protective atmosphere was applied. The kneader was operated at 50 rpm.

The block copolymer was first weighed and placed in the kneader. Approximately 10% of the amount of solid resin was then added and kneaded for 15 minutes. Then, at intervals of in each case 10 minutes, a third of the remaining amount of adhesive resin 1, adhesive resin 2 and soft resin was added and incorporated.

When the kneading operation was complete, the kneading compositions were removed from the kneader and allowed to cool to room temperature.

The cooled compositions were positioned between two layers of siliconized release paper and compressed at 130° C. by means of a type RLKV 25 hot press from Lauffer GmbH & CO KG to form hand-made samples having a layer thickness of 70 g/m². Spacers are used to establish the desired weight per unit area.

After the sample had cooled to room temperature, a layer of the siliconized release paper was replaced with a layer of a 36 μm thick etched polyester film. This method was used in Example 6.

### Example 1

| | | | |
|---|---|---|---|
| Elastomer | Vector 4111 | Styrene proportion 19% by wt. | Styrene-isoprene |
| | | Triblock proportion >99% by wt. | block copolymer |
| Adhesive resin 1 | Pentalyn H | Softening point 98° C. | Pentaerythritol |
| | | | ester of a partially |
| | | | hydrogenated |
| | | | colophony-based |
| | | | resin |
| Adhesive resin 2 | Dertoline SG2 | Softening point 85° C. | Tall oil of |
| | | | colophony |
| | | | esterified by |
| | | | glycerol |
| Soft resin | Abitol E | Softening point <25° C. | Hydroabietyl |
| | | Melt viscosity 1934 Pa * s | alcohol |

### Composition:

33% by weight elastomer,
22% by weight adhesive resin 1,
23% by weight adhesive resin 2,
22% by weight soft resin.
Solids content 40% by weight,

Solvent mixture 14% acetone, 56% petroleum ether, 30% toluene, in each case % by weight

70 g/m² adhesive on 36 μm etched PET film

Properties of the laminar pressure-sensitive adhesive medium:

| Adhesive force steel | 10.4 N/cm |
|---|---|
| Adhesive force PE | 5.3 N/cm (no slip-stick) |
| Shear adhesion | >10,000 min |
| Biogenic proportion* | 62.6% |

*calculated

### Example 2

| | | | |
|---|---|---|---|
| Elastomer | Europrene Sol | Styrene proportion 16% by wt. | Styrene-isoprene |
| | T190 | Triblock proportion 75% by wt. | block copolymer |
| Adhesive resin 1 | Granolite P | Softening point 100° C. | Pentaerythritol |
| | | | ester of a |
| | | | colophony-based |
| | | | resin |
| Adhesive resin 2 | Granolite SG | Softening point 85° C. | Glycerol ester of |
| | | | a colophony |
| Soft resin | Granolite TEG | Softening point <25° C. | Modified |
| | | Melt viscosity 29.8 Pa * s | triethylene glycol |
| | | | ester of a |
| | | | colophony |

### Composition:

39% by weight elastomer,
35% by weight adhesive resin 1,
16% by weight adhesive resin 2,
10% by weight soft resin.
Solids content 40% by weight,

Solvent mixture 14% acetone, 56% petroleum ether, 30% toluene, in each case % by weight

70 g/m² adhesive on 36 μm etched PET film

Properties of the laminar pressure-sensitive adhesive medium:

| Adhesive force steel | 15.0 N/cm |
|---|---|
| Adhesive force PE | 7.0 N/cm (no slip-stick) |
| Shear adhesion | 4600 min (cohesive failure) |
| Biogenic proportion* | 55.8% |

*calculated

### Example 3

| | | | |
|---|---|---|---|
| Elastomer | Europrene Sol | Styrene proportion 16% | Styrene-isoprene |
| | T190 | Triblock proportion 75% | block copolymer |
| Adhesive | Granolite P | Softening point 100° C. | Pentaerythritol |
| resin 1 | | | ester of a |
| | | | colophony-based |
| | | | resin |
| Adhesive | Granolite SG | Softening point 85° C. | Glycerol ester of |
| resin 2 | | | a colophony |
| Soft resin | Resiester T3 | Softening point <25° C. | Liquid colophony |
| | | Melt viscosity 34 Pa * s | ester |

### Composition:

40% by weight elastomer,
35% by weight adhesive resin 1,
15% by weight adhesive resin 2,
10% by weight soft resin.
Solids content 40% by weight,

Solvent mixture 14% acetone, 56% petroleum ether, 30% toluene, in each case % by weight

70 g/m² adhesive on 36 μm etched PET film

Properties of the laminar pressure-sensitive adhesive medium:

| Adhesive force steel | 15.4 N/cm |
|---|---|
| Adhesive force PE | 6.8 N/cm (no slip-stick) |
| Shear adhesion | >10,000 min |
| Biogenic proportion* | 55.5% |

*calculated

### Example 4

| | | | |
|---|---|---|---|
| Elastomer | Europrene | Styrene proportion 16 wt. % | Styrene-isoprene |
| | Sol T190 | Triblock proportion 75 wt. % | block copolymer |
| Adhesive | Granolite | Softening point 99° C. | Hydrogenated |
| resin 1 | P | | ester of a |
| | | | colophony-based |
| | | | resin |
| Adhesive | Granolite | Softening point 85° C. | Glycerol ester of |
| resin 2 | SG | | a hydrogenated |
| | | | colophony |
| Soft resin | Sunflower | Softening point <25° C. | |
| | oil | Melt viscosity 0.06 Pa * s | |

### Composition:

42% by weight elastomer,
36% by weight adhesive resin 1,
17% by weight adhesive resin 2,
5% by weight soft resin.
Solids content 40% by weight,

Solvent mixture 14% acetone, 56% petroleum ether, 30% toluene, in each case % by weight 70 g/m² adhesive on 36 μm etched PET film

Properties of the laminar pressure-sensitive adhesive medium:

| Adhesive force steel | 11.4 N/cm |
|---|---|
| Adhesive force PE | 5.4 N/cm |
| Shear adhesion | 4800 min (cf) |
| Biogenic proportion* | 52.6% |

*calculated

The biogenic proportion is calculated by determining the proportion by weight of all the chemical structural elements of a compound that originate from a biogenic source. Colophony, for example, originates to the extent of 100% from biogenic sources. A colophony ester is used as the resin. The alcohol used for the esterification can originate from a biogenic source (ethylene glycol) or from petrochemistry (nowadays still often pentaerythritol). The following applies for the composition in Example 4

| | Composition (% by | Proportion of biogenic raw |
|---|---|---|
| Raw material | weight) | materials |
| Europrene Sol T190 | 42% | 0% |
| Granolite P | 36% | 85% |
| Granolite SG | 17% | 100% |
| Sunflower oil | 5% | 100% |
| Total | 100% | 52.6% |

### Example 5

| | | | |
|---|---|---|---|
| Elastomer | Europrene | Styrene proportion 16 wt. % | Styrene-isoprene |
| | Sol T190 | Triblock proportion 75 wt. % | block copolymer |
| Adhesive | Pentalyn | Softening point 98° C. | Hydrogenated |
| resin 1 | H | | ester of a |
| | | | colophony-based |
| | | | resin |
| Adhesive | Foral 85 | Softening point 85° C. | Glycerol ester of |
| resin 2 | | | a hydrogenated |
| | | | colophony |
| Soft resin | Resiester | Softening point <25° C. | Triethylene glycol |
| | T3 | Melt viscosity 610 Pa * s | ester of a |
| | | | colophony-based |
| | | | resin |

### Composition:

40% by weight elastomer,
30% by weight adhesive resin 1,
20% by weight adhesive resin 2,
10% by weight soft resin.
Solids content 40% by weight,

Solvent mixture 14% acetone, 56% petroleum ether, 30% toluene, in each case % by weight

70 g/m² adhesive on 36 μm etched PET film

Properties of the laminar pressure-sensitive adhesive medium:

| Adhesive force steel | 14.9 N/cm |
|---|---|
| Adhesive force PE | 7.2 N/cm (no slip-stick) |
| Shear adhesion | >10,000 min |
| Biogenic proportion* | 55.5% |

*calculated

### Example 6

| | | | |
|---|---|---|---|
| Elastomer | Europrene | Styrene proportion 16 wt. % | Styrene-isoprene |
| | Sol T190 | Triblock proportion 75 wt. % | block copolymer |
| Adhesive | Granolite | Softening point 99° C. | Hydrogenated |
| resin 1 | P | | ester of a |
| | | | colophony-based |
| | | | resin |
| Adhesive | Granolite | Softening point 85° C. | Glycerol ester of |
| resin 2 | SG | | a hydrogenated |
| | | | colophony |
| Soft resin | Abitol E | Softening point <25° C. | Hydroabietyl |
| | | Melt viscosity 1934 Pa * s | alcohol |

### Composition:

40% by weight elastomer,
35% by weight adhesive resin 1,
15% by weight adhesive resin 2,
10% by weight soft resin.
Solids content 100% by weight,

70 g/m² adhesive on 36 μm etched PET film

Properties of the laminar pressure-sensitive adhesive medium:

| Adhesive force steel | 12.3 N/cm |
|---|---|
| Adhesive force PE | 5.5 N/cm (no slip-stick) |
| Shear adhesion | 6500 min (cohesive failure) |
| Biogenic proportion* | 54.8% |

*calculated

1. A pressure-sensitive adhesive comprising:
(i) at least one synthetic rubber based on at least one vinyl aromatic compound (A) and at least one diene (B)
comprising block copolymers as well as mixtures thereof having a structure A-B-A and/or (A-B)ₙ and derivatives thereof, wherein n is an integer greater than or equal to 2,
A is a polymer block comprising at least one vinyl aromatic compound, and
B is a polymer block comprising at least one diene, and
the proportion of the synthetic rubbers in the total composition of the pressure-sensitive adhesive is less than or equal to 45% by weight,
(ii) at least one bio-based adhesive resin and/or adhesive resin mixture which is based to the extent of greater than or equal to 85% by weight on renewable raw materials, has a softening point of greater than or equal to 80° C. and less than or equal to 110° C., and is present in a proportion of the total composition of the pressure-sensitive adhesive of from greater than or equal to 35% by weight to less than or equal to 64% by weight, and
(iii) at least one bio-based soft resin and/or soft resin mixture which is based to the extent of greater than or equal to 85% by weight on renewable raw materials and is present in a proportion of the total composition of the pressure-sensitive adhesive of from greater than or equal to 1% by weight to less than or equal to 25% by weight,
wherein the total pressure-sensitive adhesive without solvent corresponds to 100% by weight.

2. The pressure-sensitive adhesive as claimed in claim 1, wherein
the (i) at least one diene (B) is selected from the group consisting of at least one isoprene and/or from an isoprene derivative and/or the proportion thereof in the B polymer block is greater than or equal to 75% by weight.

3. The pressure-sensitive adhesive as claimed in claim 1, wherein
the (i) at least one diene linkage in the B polymer block is present to the extent of at least 85% in the form of a 1,4-linkage.

4. The pressure-sensitive adhesive as claimed in claim 3, wherein
the (i) 1,4-linkages of the dienes in the B polymer block have a ratio of 1,4-cis linkage to 1,4-trans linkage of at least 40:60.

5. The pressure-sensitive adhesive as claimed in claim 1, wherein
in the at least one (i) synthetic rubber
(1) the vinyl aromatic compound in the A polymer block is selected from the group consisting of monomers of styrene, α-methylstyrene and other styrene derivatives and the A blocks independently are homo- or co-polymers, and
(2) the B polymer block is obtained from monomers selected from the group consisting of ethylene, propylene, 1,3-diene, 1,4-diene, the diene is selected from the group consisting of at least one terpene, terpene derivative, isoprene and isoprene derivatives, and the B polymer blocks independently are homo- or co-polymers.

6. The pressure-sensitive adhesive as claimed in claim 1, wherein
the (i) proportion of the synthetic rubbers in the total composition of the pressure-sensitive adhesive is less than or equal to 40% by weight, and the at least one synthetic rubber is a styrene-isoprene block copolymer (SIS), a styrene-farnesene block copolymer and/or styrene-isoprene-butadiene block copolymer (SIBS).

7. The pressure-sensitive adhesive as claimed in claim 1, wherein
in the (i) at least one synthetic rubber
(1) the A block has a proportion of from 12% by weight to less than or equal to 30% by weight vinyl aromatic compounds in relation to the total synthetic rubber, and
(2) at least one triblock copolymer is present, and the proportion of triblock copolymers in relation to the total synthetic rubber is from greater than or equal to 50% by weight to less than or equal to 100% by weight.

8. The pressure-sensitive adhesive as claimed in claim 1, wherein
the (ii) at least one bio-based adhesive resin and/or adhesive resin mixture is present in a proportion of the total composition of the pressure-sensitive adhesive of from greater than or equal to 40% by weight to less than or equal to 64% by weight.

9. The pressure-sensitive adhesive as claimed in claim 1, wherein
the (ii) at least one bio-based adhesive resin and/or adhesive resin mixture comprises at least one resin selected from the group consisting of
(a) non-hydrogenated, partially and/or completely hydrogenated resins based on colophony,
(b) non-hydrogenated, partially and/or completely hydrogenated resins based on colophony ester,
(c) non-hydrogenated, partially and/or completely hydrogenated resins based on crude tall oil,
(d) non-hydrogenated, partially and/or completely hydrogenated resins based on crude tall oil ester, and
(e) resins based on terpene and/or the respective derivatives thereof.

10. The pressure-sensitive adhesive as claimed in claim 9, wherein
the at least one resin is present in the form of an ester and has at least one ester bond with a fatty acid, pentaerythritol, glycerol, a resin acid and/or sterane-based compounds, and/or mixtures comprising at least two of the above-mentioned esters and/or resins are present in the form of mixed esters.

11. The pressure-sensitive adhesive as claimed in claim 1, wherein
the (iii) at least one bio-based soft resin and/or soft resin mixture is present according to an alternative a) in a proportion of the total composition of the pressure-sensitive adhesive of from greater than 2.5% by weight to less than or equal to 25% by weight, wherein the at least one soft resin has a melt viscosity at 25° C. and 1 Hz of greater than or equal to 25 Pa*s, or is present according to another alternative b) in a proportion of the total composition of the pressure-sensitive adhesive of from greater than or equal to 1% by weight to less than or equal to 10% by weight.

12. The pressure-sensitive adhesive as claimed in claim 11, wherein
the (iii) at least one bio-based soft resin and/or soft resin mixture according to alternative b) has a melt viscosity at 25° C. and 1 Hz of less than or equal to 25 Pa*s.

13. The pressure-sensitive adhesive as claimed in claim 1, wherein
the (iii) at least one bio-based soft resin and/or soft resin mixture comprises at least one member of the group consisting of polyether, polyether colophony ester, polyethylene glycol, polyethylene glycol colophony ester, polypropylene glycol, polypropylene glycol colophony ester, polypropylene/polyethylene glycol colophony ester, triethylene glycol colophony ester, derivatives of triethylene glycol colophony ester, hydrogenated annellated aromatic compounds, hydroabietyl alcohol, dihydroabietyl alcohol, vegetable oil and terpene based resins.

14. The pressure-sensitive adhesive as claimed in claim 1, having a
content of solvent comprising organic-polar solvents, organic non-polar solvents and/or organic aromatic solvents of less than or equal to 70% by weight, or wherein the pressure-sensitive adhesive is optionally a solventless hot melt adhesive.

15. A laminar pressure-sensitive adhesive medium comprising a pressure-sensitive adhesive as claimed in claim 1, wherein
the pressure-sensitive adhesive is present in the form of at least one or more layers having a total weight per unit area of greater than or equal to 70 g/m².

16. The laminar pressure-sensitive adhesive medium as claimed in claim 15, comprising
(i) at least one synthetic rubber, wherein the synthetic rubber is based on the monomers A and B styrene and isoprene and the proportion of all synthetic rubbers is less than or equal to 45% by weight of the total composition of the pressure-sensitive adhesive, preferably less than or equal to 35% by weight of the total composition of the pressure-sensitive adhesive, the styrene proportion of at least one synthetic rubber is from greater than or equal to 12% by weight to less than or equal to 30% by weight, at least one type of triblock copolymer is present, and the triblock copolymer proportion, based on all the synthetic rubbers used, is at least 60% by weight,
(ii) at least one adhesive resin and/or adhesive resin mixture based to the extent of greater than or equal to 85% by weight, on renewable raw materials, wherein the adhesive resin and/or adhesive resin mixture has a softening temperature of greater than or equal to 80° C. and less than or equal to 110° C. and the proportion thereof is greater than or equal to 40% by weight of the total composition of the pressure-sensitive adhesive and
(iii) at least one soft resin and/or soft resin mixture based to the extent of greater than or equal to 85% by weight, on renewable raw materials, wherein according to an alternative a) the proportion thereof is from greater than or equal to 10% by weight to less than or equal to 25% by weight of the total composition of the pressure-sensitive adhesive, and at least one soft resin has a melt viscosity at 25° C. and 1 Hz of greater than or equal to 25 Pa*s, or according to an alternative b) the proportion thereof is from greater than or equal to 1% by weight to less than or equal to 10% by weight of the total composition of the pressure-sensitive adhesive.

17. The laminar pressure-sensitive adhesive medium as claimed in claim 15, wherein
the laminar pressure-sensitive adhesive medium comprises one or more pressure-sensitive adhesive layers,
the at least one pressure-sensitive adhesive layer has a weight per unit area of at least 70 g/m², and
the at least one pressure-sensitive adhesive layer is arranged on a laminar element.

18. The laminar pressure-sensitive adhesive medium as claimed in claim 15, wherein
(a) the at least one laminar element is selected from the group consisting of carriers, detachable laminar elements, film, release liner, transfer material and covering materials, and
(b) arrangements comprising at least two of the mentioned laminar elements.

19. The laminar pressure-sensitive adhesive medium as claimed in claim 15, wherein
(1) it has an adhesive force (according to test A) of greater than or equal to 10 N/cm on steel, and
(2) it has an adhesive force of greater than or equal to 5 N/cm on polyethylene.

20. The laminar pressure-sensitive adhesive medium as claimed in claim 15, wherein
it has a shear adhesion according to test B of greater than or equal to 2500 min.

21. The laminar pressure-sensitive adhesive medium as claimed in claim 15, wherein
the bio-based proportion of the pressure-sensitive adhesive, based on the total composition, is at least 40% by weight.

22. The laminar pressure-sensitive adhesive medium as claimed in claim 15, wherein
the laminar pressure-sensitive adhesive medium is a single- or double-sided adhesive tape, label or punched blank.

23. The laminar pressure-sensitive adhesive medium as claimed in claim 15, wherein
it is a single- or double-sided adhesive tape selected from the group consisting of self-adhesive products, single-sided adhesive tape (fabric adhesive tape), double-sided high-performance adhesive tape, carpet-laying tape, adhesive mounting tape, adhesive masking tape, transfer tape and surface-protection film.

24. A process for the production of a laminar pressure-sensitive adhesive medium as claimed in claim 15, by forming the laminar pressure-sensitive adhesive medium from the pressure-sensitive adhesive in at least one layer having a weight per unit area of at least 40 g/m².

25. The process as claimed in claim 24 for the production of a laminar pressure-sensitive adhesive medium, wherein
the laminar pressure-sensitive adhesive medium is formed by
optionally melting the pressure-sensitive adhesive or producing a pressure-sensitive adhesive comprising solvent,
applying the pressure-sensitive adhesive to a substrate, wherein
the pressure-sensitive adhesive is applied in at least one layer having a weight per unit area of greater than or equal to 40 g/m²,
optionally cooling the pressure-sensitive adhesive layer and/or removing the solvent, and
obtaining a laminar pressure-sensitive adhesive medium.

26. The process as claimed in claim 25 for the production of a laminar pressure-sensitive adhesive medium, wherein
the substrate is a carrier material, film, release liner, transfer material or covering material, wherein
a weight per unit area of the pressure-sensitive adhesive is processed to at least one pressure-sensitive adhesive layer of at least 40 g/m²,
optional drying or cooling of the pressure-sensitive adhesive applied in a laminar manner.

27. An adhesive tape obtainable by a process according to claim 24.

28. (canceled)
